(19) United States
(12) Patent Application Publication
(10) Pub. No.: US 2026/0197089 A1
(43) Pub. Date: Jul. 9, 2026

(54) SYSTEMS AND METHODS FOR EQUALIZATION ENHANCED PHASE NOISE (EEPN) TRACKING AND COMPENSATION

(71) Applicant: CIENA CORPORATION, Hanover, MD (US)

(72) Inventors: Shahab Oveis Gharan, Ottawa (CA); James S. Harley, Richmond (CA); Michael Reimer, Stittsville (CA); Kim Byron Roberts, Ottawa (CA)

(73) Assignee: CIENA CORPORATION, Hanover, MD (US)

(21) Appl. No.: 19/014,723

(22) Filed: Jan. 9, 2025

(51) Int. Cl. H04B 10/61

(52) U.S. Cl. CPC H04B 10/6161; H04B 10/6165

(57) ABSTRACT

Aspects of the subject disclosure may include, for example, calculating, by an EEPN compensation system of a coherent optical receiver, at least one metric, wherein the coherent optical receiver includes a chromatic dispersion compensation system configured to digitally compensate for chromatic dispersion relating to a signal, and a carrier phase recovery system configured to digitally recover a carrier phase associated with the signal, and wherein the calculating is based on information that is downstream of the chromatic dispersion compensation system, and utilizing, by the EEPN compensation system, the at least one metric to perform EEPN compensation relating to the signal upstream of the carrier phase recovery system. Other embodiments are disclosed.

### FIELD OF THE DISCLOSURE

The subject disclosure relates to systems and methods for equalization enhanced phase noise (EEPN) tracking and compensation.

### BACKGROUND

In a coherent optical communication system that performs digital compensation of chromatic dispersion experienced by optical signals in a fiber, the received effect of phase noises of the transmitter (Tx) laser and the receiver (Rx) (or local oscillator (LO)) laser are smeared out in time as equalization enhanced phase noise (EEPN). This makes accurate carrier phase tracking challenging especially when there are large amounts of chromatic dispersion and phase noise. A. Kakkar et al., “Comprehensive Study of Equalization-Enhanced Phase Noise in Coherent Optical Systems,” in Journal of Lightwave Technology, vol. 33, no. 23, pp. 4834-4841 Dec. 1, 2015 (which is incorporated by reference herein in its entirety), describes this EEPN effect in detail. FIG. 12 of E. Ip and J. M. Kahn, “Fiber Impairment Compensation Using Coherent Detection and Digital Signal Processing,” in Journal of Lightwave Technology, vol. 28, no. 4, pp. 502-519, 2010 (which is incorporated by reference herein in its entirety), illustrates the ideal compensation for Rx laser phase noise prior to Rx dispersion compensation and the ideal compensation for Tx laser phase noise after the Rx dispersion compensation. A. Abolfathimomtaz et al., “Equalization-Enhanced Phase Noise Compensation in Coherent Fiber Receivers,” in Journal of Lightwave Technology, vol. 42, no. 20, pp. 7155-7166 Oct. 15, 2024 (hereafter “Abolfathimomtaz” and which is incorporated by reference herein in its entirety), describes a technique in which Rx laser EEPN that results from Rx dispersion compensation is compensated for based on an estimate of the Rx laser phase noise. FIG. 4 of Abolfathimomtaz illustrates that the EEPN compensation technique is implemented in parallel with carrier phase recovery. Carrier phase recovery (also known simply as carrier recovery) is the detection and adjustment of the effect of the phase of the optical carrier. Differences in frequency and phase between the Tx laser and the Rx laser contribute variations to this phase. Abolfathimomtaz also describes a method involving the use of a pilot signal to perform EEPN compensation downstream of carrier phase recovery. Co-pending U.S. patent application Ser. No. 18/474,495, entitled “Integrated Optical Frequency Discriminator,” filed on Sep. 26, 2023, and which is incorporated by reference herein in its entirety, describes the use of a metric to compensate for Rx laser EEPN, prior to performing Rx digital chromatic dispersion compensation.

Of course, typical coherent transmission systems use both Tx and Rx digital chromatic dispersion compensation, and thus, while the Rx compensation interacts with the Rx laser phase noise to create Rx laser EEPN, the Tx compensation also interacts with the Tx laser phase noise to create Tx laser EEPN. M. S. Neves et al., “Enhanced Phase Estimation for Long-Haul Multi-Carrier Systems Using a Dual-Reference Subcarrier Approach,” in Journal of Lightwave Technology, vol. 39, no. 9, pp. 2714-2724 May 1, 2021 (which is incorporated by reference herein in its entirety), describes a technique in which two subcarriers carry known pilot information that is used to estimate the Rx laser phase noise. K. Roberts et al. U.S. Pat. No. 7,200,339 (which is incorporated by reference herein in its entirety) describes methods for reducing the phase noise of a laser. This reduces the effects of EEPN, albeit at higher cost. G. Jacobsen et al., “Study of EEPN mitigation using modified RF pilot and Viterbi-Viterbi based phase noise compensation,” in Optics Express, 2013 (which is incorporated by reference herein in its entirety), describes using polarization redundancy to enable EEPN compensation in the receiver, at the cost of halving the spectral efficiency. Sun et al. U.S. Pat. No. 7,627,252 (which is incorporated by reference herein in its entirety) describes a technique in which clock phase is detected from an optical signal with dispersion impairments. Clock phase is the sampling time relative to the symbol location in time, and is usually considered in radians or unit intervals. The error in the sampling time is referred to as jitter. Wu et al. U.S. Pat. No. 7,606,498 (which is incorporated by reference herein in its entirety) describes examples of carrier recovery in a coherent system. Oveis Gharan et al. U.S. Pat. No. 11,126,219 (which is incorporated by reference herein in its entirety) describes edgeless clock phase detection using interior spectral components. X. Zhou, “Efficient Clock and Carrier Recovery Algorithms for Single-Carrier Coherent Optical Systems: A systematic review on challenges and recent progress,” in IEEE Signal Processing Magazine, vol. 31, no. 2, pp. 35-45, March 2014 (which is incorporated by reference herein in its entirety), discusses examples of other methods of clock phase detection. M. Qiu et al., “Mitigation of Equalization Enhanced Phase Noise Using Feed-forward Timing Error Correction, ECOC 2024 (hereafter “Qiu” and which is incorporated by reference herein in its entirety), describes feed-forward clock recovery, which provides minimal EEPN compensation. A small portion of the EEPN effect instantiates as common clock jitter and so can be tracked by clock recovery algorithms such as that used by Qiu. Another portion instantiates as common carrier phase noise and so can be tracked by carrier phase recovery algorithms. The EEPN issue and the EEPN mitigation described herein refers to the rest of the EEPN that is not common to the whole signal and so cannot be mitigated by those algorithms. It is common practice to include pilot, sync, framing, training, or other known values at known locations in a transmitted symbol stream to facilitate error detection and correction, clock phase detection, carrier phase recovery, etc. There remains a need, however, for low cost and low heat methods for substantially mitigating Tx and/or Rx EEPN. Low power methods generally do not compensate for both Tx and Rx EEPN. Low power systems generally do not have Tx chromatic dispersion compensation and so do not suffer from Tx EEPN.

### BRIEF DESCRIPTION OF THE DRAWINGS

Reference will now be made to the accompanying drawings, which are not necessarily drawn to scale, and wherein:

FIG. 1A is a diagram of a non-limiting example of a communication network in accordance with various aspects described herein.

FIG. 1B is a block diagram of an example, non-limiting embodiment of a transmitter/modulator system in accordance with various aspects described herein.

FIG. 1C is a block diagram of an example, non-limiting embodiment of a receiver device in accordance with various aspects described herein.

FIG. 2A is a high-level block diagram illustrating an example location of an EEPN tracker/compensator algorithm in the signal flow relative to other digital processing blocks in a receiver, in accordance with various aspects described herein.

FIG. 2B depicts an illustrative embodiment of a method in accordance with various aspects described herein.

### DETAILED DESCRIPTION

The subject disclosure describes illustrative embodiments of an efficient method of compensating for EEPN in a coherent optical receiver. In various embodiments, the method may provide for Rx EEPN tracking by leveraging data relating to clock phase detection (or clock recovery) operations in the receiver. For best performance, there would ideally be chromatic dispersion compensation in both the Tx and the Rx. However, in certain applications, such as in low heat devices or plugs (e.g., pluggable optics), it might be more cost efficient to implement chromatic dispersion compensation only in the receiver and simply accept the performance trade-off. Where chromatic dispersion compensation is additionally implemented in the Tx, the Rx EEPN tracking method may simply not address the Tx EEPN.

In one or more embodiments, the Rx EEPN tracking method may include estimating a clock phase metric φ_{G}(b) in the frequency domain, downstream of the Rx chromatic dispersion compensation. Rx laser frequency noise \hat{v}_{Rx}(b) may be estimated from the clock phase metric using a filter—i.e., an autoregressive moving average (ARMA) filter defined as, e.g.:

$${\hat{v}}_{R x} ( b ) : = {\sum }_{m = - M}^{M} {h}_{n} ( m ) \cdot {ϕ}_{G} ( b - \frac{Δ}{2} - m ) + {\sum }_{q = - Q}^{Q} {h}_{d} ( q ) \cdot {\hat{v}}_{R x} ( b - Δ - q )$$

The EEPN correction phase term for each frequency bin f may be calculated, e.g., as follows:

$$If ⌊ d ( f ) ⌋ - \frac{Δ}{2} + M > {D}_{MAX} THEN d ( f ) = {D}_{MAX}$$

$$∀ f \vert \text{-} \frac{{F}_{s}}{2} ( 1 + α ) \leq f \leq \frac{{F}_{s}}{2} ( 1 + α ) : {θ}_{b} ( f ) := ( {Σ}_{c = 0}^{⌊ d ( f ) ⌋ - 1} {v}_{Rx} ( b + c ) ) + {v}_{RX} ( b + ⌊ d ( f ) ⌋ ) \cdot ( d ( f ) - ⌊ d ( f ) ⌋ )$$

where the EEPN correction may be applied, e.g., as follows for each frequency bin f upstream of carrier phase recovery:

$${\hat{r}}_{b} ( f ) : = {r}_{b} ( f ) \cdot {e}^{- j {θ}_{b} ( f )}$$

In this way, a clock phase detector metric can be utilized to detect the EEPN that results when the Rx laser phase noise is smeared out in time due to Rx chromatic dispersion compensation, and be used to correct the relative phase error before the carrier phase recovery process corrects the mean phase error.

D_{MAX} above denotes the delay-match buffer size in terms of number of Fast Fourier Transform (FFT) blocks b. That is, D_{MAX} determines the extent to which content in future FFT blocks b can be used to provide EEPN correction of a current FFT block. Note that the true number of non-causal taps is equal to

$$⌊ d ( f ) ⌋ - \frac{Δ}{2} + M ,$$

since the calculation of Rx laser frequency noise \hat{v}_{Rx}(b) involves a strictly causal ARMA filter that uses clock phase outputs of

$${\hat{v}}_{R x} ( b - \frac{Δ}{2} + M ) .$$

Various terms in the foregoing equations are defined further below in a brief description of the derivation of the Rx EEPN tracking algorithm.

Given that the main processing in the Rx EEPN tracking algorithm involves the calculation of a finite impulse response (FIR) filter h[b] that is applied once every FFT block, one skilled in the art would appreciate that this involves fewer calculations than that required by existing or conventional EEPN compensation methods, and thus is advantageously low heat. Embodiments of the Rx EEPN tracking method provide for robustness even against a large amount of Rx laser phase noise in the presence of a large amount of optical channel chromatic dispersion, which enables faster acquisition (i.e., handshaking, error mitigation, and overall laser centering between the Tx and the Rx) and reduces overall system cost. Systems that run at high speeds (e.g., transmit data at terabits per second (Tb/s) and symbols at hundreds of Gigabaud), use Zero Dispersion Shifted Range (ZR) or ZR+, have narrow linewidth lasers (e.g., 150 kiloHertz (KHz)), and tolerate, for instance, <=20 nanoseconds (ns)/nanometer (nm) channel chromatic dispersion, can benefit from the use of this method.

The subject disclosure also describes illustrative embodiments of an edgeless EEPN tracking method in which complex metrics relating to edgeless clock recovery are utilized to determine phase correction terms for Tx EEPN and Rx EEPN compensation. “Edgeless” refers to a signal's spectrum in the frequency domain (rather than to transitions in the time domain) in which there are little to no transitions at the edges of the spectrum (i.e., roll-off of about 0).

In one or more embodiments, the edgeless EEPN tracking method may include obtaining complex metrics m₊[b] and m₋[b] for the positive and negative spectrum halves of a signal that are typically used in edgeless clock recovery, e.g.:

$${m}_{+} [ b ] : = {\sum }_{f = 0}^{\frac{{F}_{s}}{2}} {s}^{H} [ f ] \cdot {r}_{b} [ f ]$$

$${m}_{-} [ b ] : = {\sum }_{f = - \frac{{F}_{s}}{2}}^{0} {s}^{H} [ f ] \cdot {r}_{b} [ f ]$$

However, rather than conjugate-multiplying the two complex metrics (as is usually done for edgeless clock phase estimation), individual phase estimates φ₊[b] and φ₋[b] may be obtained for the positive and negative halves of the spectrum, e.g.:

$${ϕ}_{+} [ b ] := Angle ( {m}_{+} [ b ] )$$

$${ϕ}_{-} [ b ] := Angle ( {m}_{-} [ b ] )$$

Tx and Rx laser phase noise may then be de-coupled via a proper mixing of φ₊[b] and φ₋[b], e.g.:

$${ϕ}_{T} ( b ) : = {ϕ}_{+} ( b + {τ}_{R} ) - {ϕ}_{-} ( b - {τ}_{R} )$$

$${ϕ}_{R} ( b ) : = {ϕ}_{-} ( b + {τ}_{T} ) - {ϕ}_{+} ( b - {τ}_{T} )$$

such that φ_{T}(b) is expected to have no Rx laser phase noise contribution, and φ_{R}(b) is expected to have no Tx laser phase noise contribution. Tx and Rx laser frequency noise values \hat{v}_{Tx}(t) and \hat{v}_{Rx}(t) may be estimated using a Wiener filter solution for minimum mean square error (MMSE), e.g.:

$${h}_{T x} ( t ) := {( Toeplitz ( {R}_{{ϕ}_{T}} ( t ) ) )}^{- 1} \cdot {R}_{{ϕ}_{T} , {v}_{T x}} ( t )$$

$${h}_{R x} ( t ) : = {( Toeplitz ( {R}_{{ϕ}_{R}} ( t ) ) )}^{- 1} \cdot {R}_{{ϕ}_{R ,} {v}_{R x}} ( t )$$

$${\hat{v}}_{T x} ( t ) : = {h}_{T x} ( t ) * {ϕ}_{T} ( t )$$

$${\hat{v}}_{R x} ( t ) : = {h}_{R x} ( t ) * {ϕ}_{R} ( t )$$

Tx and Rx laser phase walk-off correction terms ψ_{Tx,b}(f) and ψ_{Rx,b}(f) may then be calculated for each frequency bin f, e.g., as follows:

$$∀ f \vert \vert f \vert \leq \frac{{F}_{s}}{2} \text{:} {ψ}_{Tx , b} ( f ) = {\hat{v}}_{Tx} ( b + ⌊ {o}_{T} ( f ) ⌋ ) \cdot ( {o}_{T} ( f ) - ⌊ {o}_{T} ( f ) ⌋ ) + {\sum }_{c = 0}^{⌊ {o}_{T} ( f ) ⌋ - 1} {\hat{v}}_{Tx} ( b + c )$$

$$∀ f \vert \vert f \vert \leq \frac{{F}_{s}}{2} \text{:} {ψ}_{Rx , b} ( f ) = {\hat{v}}_{Rx} ( b + ⌊ {o}_{R} ( f ) ⌋ ) \cdot ( {o}_{R} ( f ) - ⌊ {o}_{R} ( f ) ⌋ ) + {\sum }_{c = 0}^{⌊ {o}_{R} ( f ) ⌋ - 1} {\hat{v}}_{Rx} ( b + c )$$

$$where$$

$${o}_{T} ( f ) : = \frac{4 \cdot f \cdot {τ}_{T}}{{F}_{s}} , {o}_{R} ( f ) : = - \frac{4 \cdot f \cdot {τ}_{R}}{{F}_{s}}$$

$$∀ f \vert - \frac{{F}_{s}}{2} \leq f < \frac{{F}_{s}}{2} : {\hat{r}}_{b} [ f ] : = {r}_{b} [ f ] \cdot {e}^{- j ( {ψ}_{Tx , b} ( f ) + {ψ}_{Rx , b} ( f ) )}$$

Various terms in the foregoing equations are defined further below in a brief description of the derivation of the edgeless EEPN tracking method. Also, implementation details of an arbitrary-FDM extension of the method are also discussed further below.

Embodiments of the edgeless EEPN tracking method are particularly useful in systems where chromatic dispersion compensation is implemented in both the coherent optical transmitter and the coherent optical receiver. Compensating for both Tx EEPN and Rx EEPN advantageously provides for improved signal-to-noise ratio (SNR) on long paths and also allows for the use of more cost efficient lasers.

One or more aspects of the subject disclosure include a coherent optical receiver that includes an EEPN compensation system that is configured to perform operations. The operations may include calculating at least one metric based on information that is downstream of a chromatic dispersion compensation system that digitally compensates for chromatic dispersion relating to a signal. The operations may further include utilizing the at least one metric to perform EEPN compensation relating to the signal upstream of a carrier phase recovery system that digitally recovers a carrier phase associated with the signal.

One or more aspects of the subject disclosure include a method. The method may include calculating, by an EEPN compensation system of a coherent optical receiver, at least one metric, wherein the coherent optical receiver includes a chromatic dispersion compensation system configured to digitally compensate for chromatic dispersion relating to a signal, and a carrier phase recovery system configured to digitally recover a carrier phase associated with the signal, and wherein the calculating is based on information that is downstream of the chromatic dispersion compensation system. The method may further include utilizing, by the EEPN compensation system, the at least one metric to perform EEPN compensation relating to the signal upstream of the carrier phase recovery system.

One or more aspects of the subject disclosure include a non-transitory machine-readable medium, comprising executable instructions that, when executed by a processing system of a coherent optical receiver including a processor, facilitate performance of operations. The operations may include calculating at least one metric, wherein the coherent optical receiver includes a chromatic dispersion compensation system configured to digitally compensate for chromatic dispersion relating to a signal, and a carrier phase recovery system configured to digitally recover a carrier phase associated with the signal, and wherein the calculating is based on information that is downstream of the chromatic dispersion compensation system. The operations may further include utilizing, by the EEPN compensation system, the at least one metric to perform EEPN compensation relating to the signal upstream of the carrier phase recovery system.

Other embodiments are described in the subject disclosure.

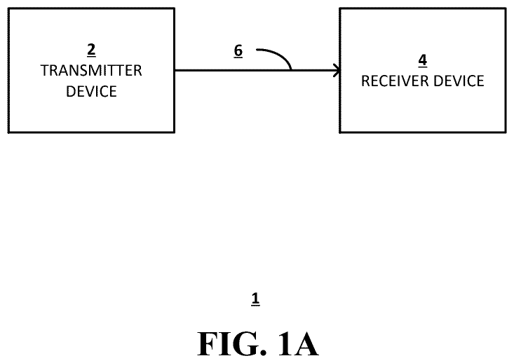

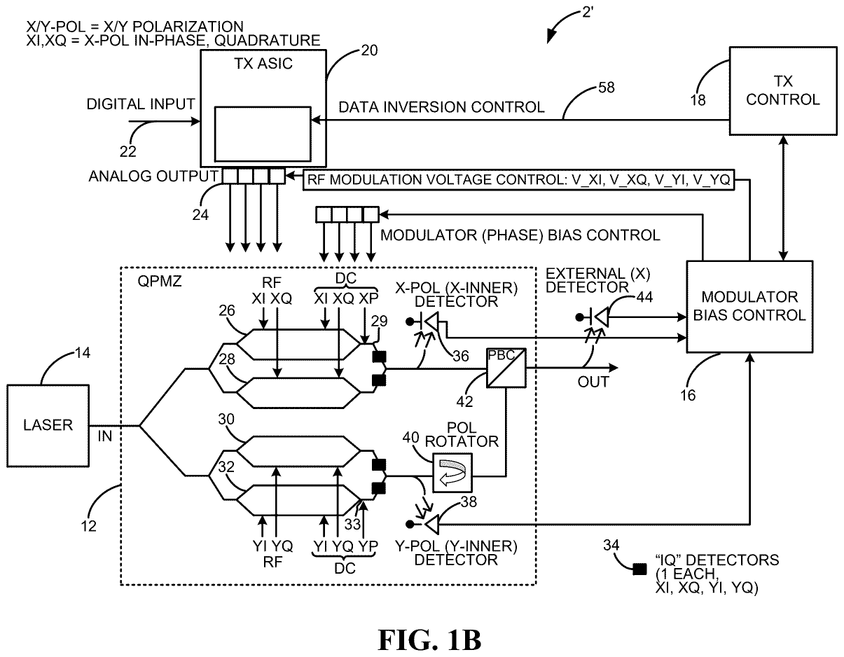

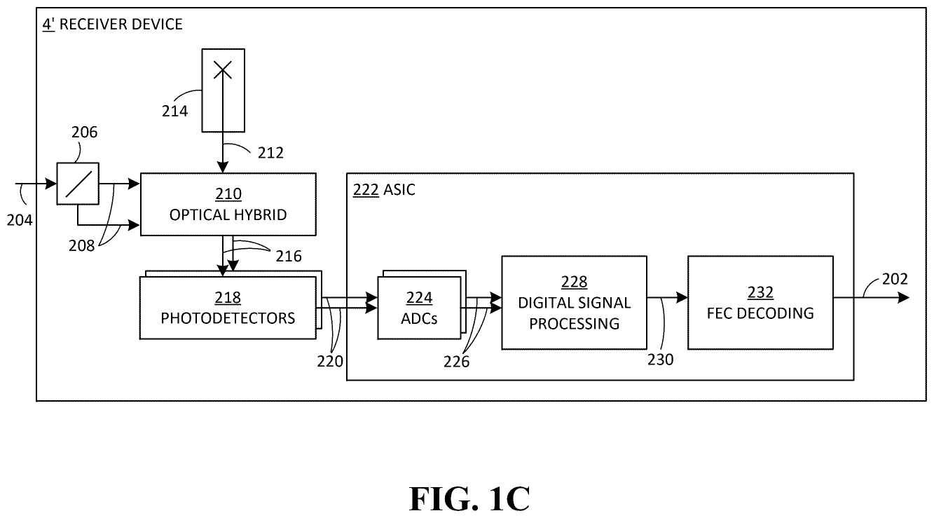

FIG. 1A is a diagram of a non-limiting example of a communication network 1 in accordance with various aspects described herein. The communication network 1 may include at least one transmitter device 2 and at least one receiver device 4. The transmitter device 2 may be capable of transmitting signals over a communication channel, such as a communication channel 6. The receiver device 4 may be capable of receiving signals over a communication channel, such as the communication channel 6. In various embodiments, the transmitter device 2 may also be capable of receiving signals and/or the receiver device 4 may also be capable of transmitting signals. Thus, one or both of the transmitter device 2 and the receiver device 4 may be capable of acting as a transceiver.

The communication network 1 may include additional elements not shown in FIG. 1A. For example, the communication network 1 may include one or more additional transmitter devices, one or more additional receiver devices, and one or more other devices or elements involved in the communication of signals in the communication network 1.

In some embodiments, the signals that are transmitted and received in the communication network 1 may include optical signals and/or electrical signals. For example, the transmitter device 2 may be a first electrical-based transceiver, the receiver device 4 may be a second electrical-based transceiver, and the communication channel 6 may be an electrical communication channel (e.g., a coaxial cable, a printed circuit board (PCB) trace, or the like). For instance, the communication network 1 may include a SerDes system. As another example, the transmitter device 2 may be a first optical transceiver, the receiver device 4 may be a second optical transceiver, and the communication channel 6 may be an optical communication channel. In certain embodiments, one or both of the first optical transceiver and the second optical transceiver may be a coherent modem.

Where the communication network 1 involves the transmission of optical signals, the communication network 1 may include additional optical elements not shown in FIG. 1A, such as wavelength selective switches, optical multiplexers, optical de-multiplexers, optical filters, and/or the like. Furthermore, each optical communication channel in the communication network 1 may include one or more links, where each link may include one or more spans, and where each span may include a length of optical fiber and one or more optical amplifiers.

Various elements and effects in an optical link between two communicating devices may result in the degradation of transmitted signals. That is, optical signals received over optical links can become distorted. Particularly, these signals may suffer from polarization mode dispersion (PMD), polarization dependent loss or gain (PDL or PDG), state of polarization (SOP) rotation, amplified spontaneous emission (ASE) noise, wavelength-dependent dispersion or chromatic dispersion (CD), nonlinear noise from propagation through fiber, and/or other effects. For instance, polarization effects of a fiber link tend to rotate the transmitted polarizations such that, at the receiver, they are neither orthogonal to each other nor aligned with the polarization beam splitter of the optical hybrid. As a result, each of the received polarizations (e.g., downstream of the polarization beam splitter) may contain energy from both of the transmitted polarizations, as well as distortions due to CD, PMD, PDL, etc. These problems may be compounded for polarization-division multiplexed signals in which each transmitted polarization contains a respective data signal. The degree of signal degradation due to noise and nonlinearity may be characterized by a signal-to-noise ratio (SNR) or, alternatively, by a noise-to-signal ratio (NSR). The signals transmitted in the communications network may be representative of digital information in the form of bits or symbols. The probability that bit estimates recovered at a receiver differ from the original bits encoded at a transmitter may be characterized by the Bit Error Ratio (BER). As the noise power increases relative to the signal power, the BER may also increase.

FIG. 1B is a block diagram of an example, non-limiting embodiment of a transmitter/modulator system 2′ in accordance with various aspects described herein. In one or more embodiments, the transmitter/modulator system 2′ may correspond to the transmitter 2 of FIG. 1A. As shown in FIG. 1B, the transmitter device 2′ may include a combination of optical and electrical components, such as, for example, a modulator 12, a laser 14, a modulator bias controller 16, a transmitter (Tx) controller 18, and a Tx application specific integrated circuit (ASIC) 20. The modulator 12 may employ nested Mach-Zehnder (MZ) architecture(s)—i.e., two dual-parallel MZs (DPMZs), each with two inner MZs and one outer MZ-resulting in a quad parallel MZ (QPMZ) modulator.

In one or more embodiments, the optical modulator system 2′ may be equipped to control four quadrature data signals (i.e., radio frequency (RF) XI, RF XQ, RF YI, RF YQ signals, where X, Y denote polarization and I, Q denote in-phase and quadrature, respectively) via the Tx ASIC 20. The modulator 12 may include an XI modulator 26, an XQ modulator 28, and an outer phase modulator 29 (respectively functioning as two inner MZs nested within an outer MZ for the X polarization) as well as a YI modulator 30, a YQ modulator 32, and an outer phase modulator 33 (respectively functioning as two inner MZs nested within an outer MZ for the Y polarization). Each MZ may have one or two DC electrodes depending on the implementation of the MZ. The laser 14 may provide a laser output for modulation by the modulator 12. The laser output may be divided (e.g., via a beam splitter) into X and Y polarizations, where the X polarization may be further divided (e.g., via another beam splitter) into an optical I input that is fed into an X-pol I-arm (i.e., the XI modulator 26) and an optical Q input that is fed into an X-pol Q-arm (i.e., the XQ modulator 28), and where the Y polarization may be further divided (e.g., via yet another beam splitter) into an optical I input that is fed into a Y-pol I-arm (i.e., the YI modulator 30) and an optical Q input that is fed into a Y-pol Q-arm (i.e., the YQ modulator 32). The modulator 12 may be capable of independently generating orthogonal optical electric field components (I channel and Q channel) for each polarization X and Y, according to various types of multi-value modulation methods, such as N-quadrature amplitude modulation (QAM), differential quadrature phase shift keying (D-QPSK), etc.

In general operation, the Tx ASIC 20 may receive a digital information stream at a digital input 22 and convert the digital information stream (based on an associated modulation scheme) for driving the modulator 12 via analog outputs 24 (RF XI, RF XQ, RF YI, RF YQ). The analog outputs 24 may be communicatively coupled to the modulator 12. In some embodiments, the Tx ASIC 20 may include a digital filter that provides a transfer function H on the received digital input 22. A digital-to-analog (D/A) converter may be connected to an output of the digital filter, and an analog amplifier may be connected to an output of the D/A converter to provide a gain G. An output of the analog amplifier may provide the analog output 24 to the modulator 12. In certain embodiments, a controller may be connected to the digital filter and the analog amplifier to control the transfer function H and/or the gain G responsive to a data inversion control signal 58 from the Tx controller 18.

A detector 34 (also referred to as a tap-detector) may be included at an output of each of the modulators 26, 28, 30, 32. In certain embodiments, some or all of the modulators 26, 28, 30, 32 may be referred to as inner modulators and can be amplitude, phase, or mixed phase/amplitude modulators. In one or more embodiments, some or all of the modulators 26, 28, 30, 32 may be phase modulators. As shown, the modulator 12 may include an X-polarization detector 36 that is coupled to a combined output of the modulators 26, 28 (or the output of the outer MZ 29), and a Y-polarization detector 38 that is coupled to a combined output of the modulators 30, 32 (or the output of the outer MZ 33). A polarization rotator 40 may be connected to the combined output of the modulators 30, 32. A polarization beam combiner 42 may be connected to the combined output of the modulators 26, 28 and the combined output of the modulators 30, 32. An output of the polarization beam combiner 42 may provide a modulated output of the modulator 12, and an external detector 44 may be tapped off of the output. The various detectors 34, 36, 38, 44 may be communicatively coupled to the modulator bias controller 16.

As shown in FIG. 1B, several modulator bias points of the modulator 12 may be controlled or optimized via the modulator bias controller 16. In some embodiments, the Tx controller 18 may control the Tx ASIC 20 and/or the modulator bias controller 16. In various embodiments, the Tx controller 18 may control the modulator bias controller 16 in the following ways: (i) open loop control where bias control loops can be opened, enabling direct control of biases and measurement of the detectors 34, 36, 38, 44; and/or (ii) closed loop control where the feedback polarity of the modulator bias controller 16 can be set, but where the modulator bias controller 16 itself implements the feedback control. The Tx controller 18 may identify (e.g., optimum) bias points whereas the modulator bias controller 16 may maintain those points in service. In some embodiments, the modulator bias controller 16 may control the generated analog output signals of the Tx ASIC 20, rather than control bias values of the modulator 12.

FIG. 1C is a block diagram of an example, non-limiting embodiment of a receiver device 4′ in accordance with various aspects described herein. In one or more embodiments, the receiver device 4′ may correspond to the receiver 4 of FIG. 1A. In various embodiments, the receiver device 4′ may be configured to receive an optical signal 204, which may comprise a degraded version of an optical signal generated by a transmitter device (e.g., the transmitter device 2′ of FIG. 1B). The optical signal generated by the transmitter device may be representative of information bits (also referred to as client bits) which are to be communicated to the receiver device 4′. The optical signal generated by the transmitter device may be representative of a stream of symbols. According to some examples, the transmitter device may be configured to apply forward error correction (FEC) encoding to the client bits to generate FEC-encoded bits, which may then be mapped to one or more streams of data symbols. The optical signal transmitted by the transmitter device may be generated using any of a variety of techniques, such as frequency division multiplexing (FDM), polarization-division multiplexing (PDM), single polarization modulation, modulation of an unpolarized carrier, mode-division multiplexing, spatial-division multiplexing, Stokes-space modulation, polarization balanced modulation, wavelength division multiplexing (WDM) (where a plurality of data streams is transmitted in parallel, over a respective plurality of carriers, and where each carrier is generated by a different laser), and/or the like.

The receiver device 4′ may be configured to recover corrected client bits 202 from the received optical signal 204. The receiver device 4′ may include a polarizing beam splitter 206 configured to split the received optical signal 204 into polarized components 208. According to one example implementation, the polarized components 208 may include orthogonally polarized components corresponding to an X polarization and a Y polarization. An optical hybrid 210 may be configured to process the components 208 with respect to an optical signal 212 produced by a laser 214, thereby resulting in optical signals 216. Photodetectors 218 may be configured to convert the optical signals 216 output by the optical hybrid 210 to analog electrical signals 220. The frequency difference between the Rx laser and the Tx laser is the Intermediate Frequency, and an offset of that away from nominal can be called fIF. (The nominal difference is usually zero.) According to one example implementation, the analog electrical signals 220 may include four signals corresponding, respectively, to the dimensions XI, XQ, YI, and YQ, where XI and XQ denote the in-phase and quadrature components of the X polarization, and YI and YQ denote the in phase and quadrature components of the Y polarization. Together, elements such as the beam splitter 206, the laser 214, the optical hybrid 210, and the photodetectors 218 may form a communication interface configured to receive optical signals from other devices in a communication network.

As shown in FIG. 1C, the receiver device 4′ may include an ASIC 222. The ASIC 222 may include analog-to-digital converters (ADCs) 224 that are configured to sample the analog electrical signals 220 and generate respective digital signals 226. In certain alternate embodiments, the ADCs 224 or portions thereof may be separate from the ASIC 222. The ADCs 224 may sample the analog electrical signals 220 periodically at a sample rate that is based on a signal received from a voltage-controlled oscillator (VCO) at the receiver device 4′ (not shown). The ASIC 222 may be configured to apply digital signal processing to the digital signals 226 using a digital signal processing system 228. The digital signal processing system 228 may be configured to perform equalization processing that is designed to compensate for a variety of channel impairments, such as CD, SOP rotation, mean PMD that determines the probability distribution which instantiates as differential group delay (DGD), PDL or PDG, and/or other effects. The digital signal processing system 228 may further be configured to perform carrier recovery processing, which may include calculating an estimate of carrier frequency offset fIF (i.e., the difference between the frequency of the transmitter laser and the frequency of the receiver laser 214). According to some example implementations, the digital signal processing system 228 may further be configured to perform operations such as multiple-input-multiple-output (MIMO) filtering, clock recovery, and FDM subcarrier de-multiplexing. The digital signal processing system 228 may also be configured to perform symbol-to-bit demapping (or decoding) using a decision circuit, such that signals 230 output by the digital signal processing system 228 are representative of bit estimates. Where the received optical signal 204 is representative of symbols comprising FEC-encoded bits generated as a result of applying FEC encoding to client bits, the signals 230 may further undergo FEC decoding 232 to recover the corrected client bits 202.

According to some example implementations, the equalization processing implemented as part of the digital signal processing system 228 may include one or more equalizers, some or all of which may be configured to compensate for impairments in the channel response. In general, an equalizer applies a substantially linear filter to an input signal to generate an output signal that is less degraded than the input signal. The filter may be characterized by compensation coefficients which may be incrementally updated from time to time (e.g., every so many clock cycles or every so many seconds) with the goal of reducing the degradation observed in the output signal.

Turning now to the Rx EEPN tracking method (and focusing solely on the X polarization (X-Pol) for the sake of brevity, with the understanding that the same or similar steps may be applied to the Y polarization (Y-Pol)), let r_{b}(f) represent the content in a received X-Pol frequency bin f of an FFT block b after Rx chromatic dispersion compensation, and let s_{b}(f) represent the content in a corresponding transmitted frequency bin f of FFT block b. Assuming that there is no Additive White Gaussian Noise (AWGN), that clock offset/jitter t is in unit intervals, and the approximation that the laser phase noise is constant over the time duration of one FFT block b, we expect:

$${r}_{b} ( f ) = {e}^{j ( {ϕ}_{T x} ( b ) + {ϕ}_{R x} ( b + \frac{f}{{F}_{s}} Δ ) + \frac{f}{{F}_{s}} \cdot 2 π \cdot τ )} \cdot {s}_{b} ( f )$$

where φ_{Rx}(b) and φ_{Tx}(b) are the Rx and Tx laser phase noises corresponding to the FFT block with index b, and Δ is the walk-off that is experienced due to chromatic dispersion in the channel between

$$\frac{{F}_{s}}{2} and - \frac{{F}_{s}}{2}$$

(where Fₛ is the baud rate) and that is calculated in units of number of FFT blocks.

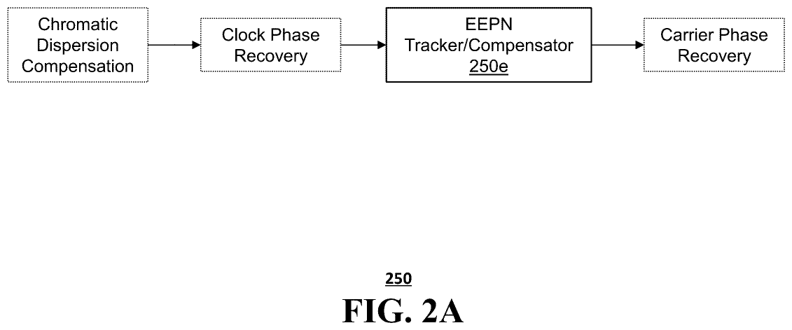

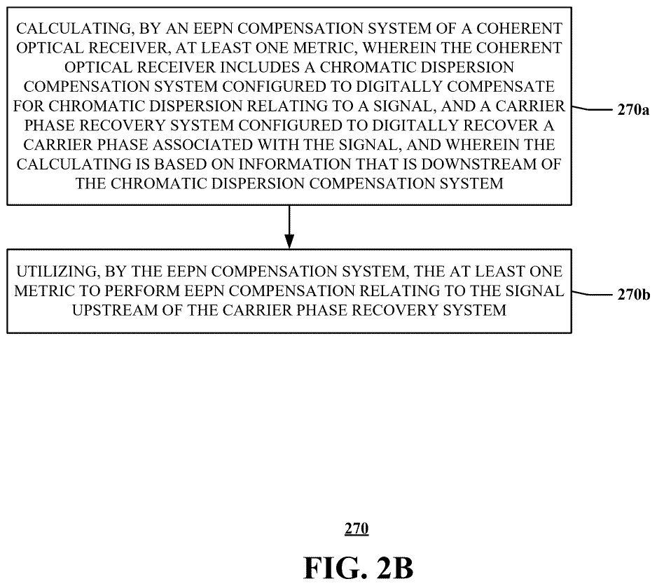

Let φ_{G}(b) be the output of a clock phase detector (e.g., the clock phase recovery block in FIG. 2A) for each FFT block b, which is the sum of any clock recovery offset and the delay effect of chromatic dispersion that is associated with the Rx laser phase noise. For any frequency f where there is energy at both r_{b}(f) and r_{b}(f−Fₛ), the detected clock phase, in the absence of AWGN and assuming no clock jitter (t=0), is:

$${ϕ}_{G} ( b ) = {ϕ}_{R x} ( b + \frac{Δ}{2} ) - {ϕ}_{R x} ( b - \frac{Δ}{2} )$$

Hence, Rx laser phase noise φ_{Rx}(b) can be reconstructed by collecting the clock phase detector outputs for different FFT blocks φ_{G}(b, b−1, b−2, . . . ).

Rather than recovering the absolute Rx laser phase noise, a differential Rx laser phase noise

$${ϕ}_{R x} ( b + \frac{f}{{F}_{s}} \cdot Δ ) - {ϕ}_{R x} ( b )$$

can be obtained, which when eliminated from the signal means that all frequency bins f observe a common Rx laser phase noise value φ_{Rx}(b) that the time-domain carrier recovery circuit (e.g., the rightmost block in FIG. 2A) can track. Letting incremental Rx laser frequency noise v_{Rx}(b) be defined as:

$${v}_{R x} ( b ) : = {ϕ}_{R x} ( b + 1 ) - {ϕ}_{R x} ( b )$$

and the frequency induced time walk-off between frequency f and direct current (DC) to be defined as:

$$d ( f ) : = \frac{f}{{F}_{s}} \cdot Δ$$

allows for the differential laser phase noise corresponding to frequency f to be estimated as:

$${θ}_{b} ( f ) : = {ϕ}_{Rx} ( b + \frac{f}{{F}_{s}} \cdot Δ ) - {ϕ}_{Rx} ( b ) = {v}_{Rx} ( b + ⌊ d ( f ) ⌋ ) \cdot ( d ( f ) - ⌊ d ( f ) ⌋ ) + {\sum }_{c = 0}^{⌊ d ( f ) ⌋ - 1} {v}_{Rc} ( b + c )$$

Applying the differential phase correction to the received content of frequency f results in:

$${\hat{r}}_{b} ( f ) := {r}_{b} ( f ) \cdot {e}^{- j {θ}_{b} ( f )} = {e}^{- j ( {ϕ}_{R x} ( b + \frac{f}{{F}_{s}} \cdot Δ ) - {ϕ}_{R x} ( b ) )} \cdot {e}^{j ( {ϕ}_{T x} ( b ) + {ϕ}_{R x} ( b + \frac{f}{{F}_{s}} Δ ) )} \cdot {s}_{b} ( f ) = {e}^{j ( {ϕ}_{T x} ( b ) + {ϕ}_{R x} ( b ) )} \cdot {s}_{b} ( f )$$

In this way, EEPN noise may be translated into a common phase noise that can easily be tracked by the carrier phase recovery process.

To (e.g., optimally) estimate v_{Rx}(b) from φ_{G}(b), Wiener filter taps that, when convolved with the clock phase detector output, provide an MMSE estimate of laser frequency noise v_{Rx}(b), can be analytically learned. The optimum solution of a 2K+1 tap Wiener filter h [−K . . . . K] that best estimates Rx laser frequency noise v_{Rx}(b) from the clock phase detector output φ_{G}(b) is:

$${h}_{opt} : = {R}_{{ϕ}_{G} , {v}_{R x}} \cdot {R}_{{ϕ}_{G}}^{- 1}$$

where R_{φ}_{_{G}}_{,v}_{_{Rx}} is the cross-correlation vector between OG (b) and v_{Rx}(b), and R_{φ}_{_{G}} is the Toeplitz matrix that is calculated from the autocorrelation function of φ_{G}(b). Assuming that both the clock phase detector background noise and the Rx laser frequency noise v_{Rx}(b) are white, the Toeplitz matrix R_{φ}_{_{G}} can be calculated from R_{φ}(τ) as:

$${R}_{{ϕ}_{G}} : = [ \begin{matrix}{R}_{ϕ} ( 0 ) & {R}_{ϕ} ( 1 ) & {R}_{ϕ} ( 2 ) & ⋯ \\ {R}_{ϕ} ( 1 ) & {R}_{ϕ} ( 0 ) & {R}_{ϕ} ( 1 ) & ⋯ \\ {R}_{ϕ} ( 2 ) & {R}_{ϕ} ( 1 ) & {R}_{ϕ} ( 0 ) & ⋯ \\ ⋯ & ⋯ & ⋯ & ⋯\end{matrix} ]$$

Further, the cross-correlation function R_{φ}_{_{G}}_{,v}_{_{Rx}} can be calculated as:

$${R}_{{ϕ}_{G} , {v}_{Rx}} ( τ ) : = E \{ {ϕ}_{G} ( b ) \cdot {v}_{Rx} ( b + τ ) \} = max ( 0 , min ( \frac{Δ}{2} , τ + 1 ) - max ( - \frac{Δ}{2} , τ ) ) \cdot \frac{{N}_{NOS} \cdot 2 \cdot π \cdot {L}_{LW}}{{F}_{s}}$$

where N_{NOS} is the number of non-overlapping symbols of the Inverse FFT (IFFT), and L_{LW} is laser linewidth in Hz. The Wiener filter solution hₒₚₜ can then be determined from the results of these two calculations.

A pure Wiener filter implementation would require hundreds of taps in time in order to provide suitable performance. To simplify, the Wiener filter can be approximated such that only the Rx laser frequency noise for b and b−Δ are used, i.e. where:

$${\hat{v}}_{R x} ( b ) = {\sum }_{l = 0}^{L} {\sum }_{m = - M}^{M} {h}_{l} ( m ) \cdot {ϕ}_{G} ( b - \frac{Δ}{2} - l Δ - m )$$

This lends to the possibility of a further approximation of the Wiener filter by an ARMA filter, where the terms contributing to the Wiener filter corresponding to l>0 are modeled by an infinite impulse response (IIR) portion of the ARMA filter, i.e., as:

$$H ( z ) = \frac{{z}^{- \frac{Δ}{2}} {Σ}_{m = - M}^{M} {h}_{n} ( m ) {z}^{- m}}{1 - {z}^{- Δ} {Σ}_{q = - Q}^{Q} {h}_{d} ( q ) {z}^{- q}}$$

where hₙ(m) and h_{d}(m) denote the nominator and denominator polynomials respectively and the denominator filter is assumed to have 2Q+1 taps. In this way, the overall filtering can be modeled as:

$${\hat{v}}_{R x} ( b ) : = {\sum }_{m = - M}^{M} {h}_{n} ( m ) \cdot {ϕ}_{G} ( b - \frac{Δ}{2} - m ) + {\sum }_{q = - Q}^{Q} {h}_{d} ( q ) \cdot {\hat{v}}_{R x} ( b - Δ - q )$$

Focusing now on the edgeless EEPN tracking method, let r_{b}[f] represent a 2×1 vector composed of X-Pol and Y-Pol projections that correspond to a received FFT block b and frequency bin f:

$${r}_{b} [ f ] : = {[ {r}_{b X} [ f ] , {r}_{b , Y} [ f ] ]}^{T}$$

Assuming that known symbols are present in a significant proportion of the received FFT blocks, and where a 2×1 frequency-template vector s[f] corresponding to frequency bin f is used for edgeless clock recovery, positive-side and negative-side complex estimates m₊ and m₋ may be obtained by cross-correlating the received FFT vector with the frequency-template vector over positive and negative halves of the signal spectrum, as follows:

$${m}_{+} [ b ] : = {\sum }_{f = 0}^{\frac{{F}_{s}}{2}} {s}^{H} [ f ] \cdot {r}_{b} [ f ]$$

$${m}_{-} [ b ] : = {\sum }_{f = - \frac{{F}_{s}}{2}}^{0} {s}^{H} [ f ] \cdot {r}_{b} [ f ]$$

where s^{H}[f] denotes the complex Hermitian (i.e., conjugate transpose) of vector s[f]. Rather than calculating the Angle(m₊·m*₋) as would typically be done in edgeless clock recovery, the individual angles of m₊ and m₋ may be calculated instead:

$${ϕ}_{+} [ b ] : = Angle ( {m}_{+} [ b ] )$$

$${ϕ}_{-} [ b ] : = Angle ( {m}_{-} [ b ] )$$

To better track the impact of EEPN on the positive and negative clock phase values φ₊[b] and φ₋[b], let θ_{Tx}(b) and θ_{Rx}(b) represent the Tx and Rx laser phase noises, respectively. In an example walk-off model, let τ_{T} and τ_{R} represent the walk-offs between centers of the positive and negative halves of the spectrum with respect to DC (0 Hz frequency) that result from Tx and Rx chromatic dispersion compensation, and let τ_{C} represent the walk-offs between the centers of the spectrum halves and DC that result from chromatic dispersion in the fiber. Per the walk-off model, the relationships between positive and negative phase estimates φ₊(b) and φ₋(b) and the true or actual Tx and Rx laser phase noise values θ_{Tx} and θ_{Rx} are as follows:

$${ϕ}_{+} ( b ) = {W}_{{τ}_{T}} ( b ) * {θ}_{T x} ( b + {τ}_{T} ) + {w}_{{τ}_{R}} ( b ) * {θ}_{R x} ( b - {τ}_{R} )$$

$${ϕ}_{-} ( b ) = {W}_{{τ}_{T}} ( b ) * {θ}_{T x} ( b - {τ}_{T} ) + {w}_{{τ}_{R}} ( b ) * {θ}_{R x} ( b + {τ}_{R} )$$

where w_{τ}_{_{T}}(b) and w_{τ}_{_{T}}(b) are rectangular FIRs with respective taps 2τ_{T}+1 and 2τ_{R}+1 of equivalent width. A generic FIR w_{d}(t) may thus be defined as:

$${w}_{d} ( t ) : = \{ \begin{matrix}\frac{1}{2 \cdot Round ( d ) + 1} & if \vert t \vert \leq Round ( d ) \\ 0 & otherwise\end{matrix}$$

The Tx and Rx laser phase noise estimates φ_{T}(b) and φ_{R}(b) may be decoupled from one another to facilitate better tracking, by delaying the estimate of one spectrum half estimate and subtracting it from the estimate of the other spectrum half. Letting incremental Tx laser frequency noise v_{Tx}(b) and incremental Rx laser frequency noise v_{Rx}(b) be defined as:

$${v}_{R x} ( b ) : = {θ}_{R x} ( b ) - {θ}_{R x} ( b - 1 )$$

$${v}_{T x} ( b ) : = {θ}_{T x} ( b ) - {θ}_{T x} ( b - 1 ) ,$$

the respective relationships between the edgeless Tx and Rx laser phase noise estimates φ_{T}(b) and φ_{R}(b) and the Tx and Rx laser frequency noise values v_{Tx}(b) and v_{Rx}(b) are as follows:

$${ϕ}_{T} ( b ) = {w}_{{τ}_{T}} ( b ) * {w}_{{τ}_{T} + {τ}_{R}} ( b ) * {v}_{T x} ( b )$$

$${ϕ}_{R} ( b ) = {w}_{{τ}_{R}} ( b ) * {w}_{{τ}_{T} + {τ}_{R}} ( b ) * {v}_{R x} ( b )$$

Rather than recovering the absolute Tx and Rx laser phase noises, differential laser phase noise (i.e. laser frequency noise) can be obtained to facilitate correction of Tx and Rx laser phase walk-offs across the spectrum such that the laser phase noise is generally aligned in the signal's spectrum. Carrier phase recovery is assumed to then (e.g., fully) correct for the remaining common laser phase noise. To elaborate, the main cause of Tx/Rx EEPN is the presence of phase noise of the Tx/Rx laser. In the absence of chromatic dispersion compensation, this laser phase noise remains temporally aligned across the signal's spectrum, which allows for straightforward correction in the time domain by way of carrier phase recovery. Because chromatic dispersion introduces a delay as a function of frequency, chromatic dispersion compensation involves the application of an opposite delay as a function of frequency to counter the degradation effect. However, such compensation undesirably delays the laser phase noise as a function of frequency such that the laser phase noise is no longer temporally aligned across the signal's spectrum. As a consequence, the original laser phase noise experiences different time delays across various frequencies, resulting in EEPN. Applying the Tx and Rx laser phase walk-off corrections described herein advantageously seeks to bring the laser phase noise back into (e.g., perfect or near perfect) temporal alignment across the signal's spectrum, resulting in mere common laser phase noise that carrier phase recovery can easily track.

To (e.g., optimally) estimate v_{Tx}(b) from φ_{T}(b), Wiener filter taps can be analytically learned by calculating the auto-correlation function of φ_{T}(b) as well as the cross-correlation between φ_{T}(b) and v_{Tx}(b):

$${R}_{{ϕ}_{T}} ( t ) : = E \{ {ϕ}_{T} ( t ) * {ϕ}_{T} ( - t ) \} = \frac{2 π \cdot {L}_{w}}{{F}_{s}} \cdot {w}_{{τ}_{T}} ( b ) * {w}_{{τ}_{T}} ( b ) * {w}_{{τ}_{T} + {τ}_{R}} ( b ) * {w}_{{τ}_{T} + {τ}_{R}} ( b ) + {σ}_{AWGN}^{2} \cdot δ ( t )$$

$${R}_{{ϕ}_{T} , {v}_{T x}} ( t ) : = E \{ {ϕ}_{T} ( t ) * {v}_{T x} ( - t ) \} = \frac{2 π \cdot {L}_{w}}{{F}_{s}} \cdot {w}_{{τ}_{T}} ( b ) * {w}_{{τ}_{T} + {τ}_{R}} ( b )$$

where σ_{AWGN} is the standard deviation of the noise that is present in the EEPN estimation due to ASE noise, L_{W} is the laser linewidth in Hz, and δ(t) is the Dirac delta function. R_{φ}_{_{T}}(t) allows for the derivation of the Toeplitz auto-correlation matrix of φ_{T}(b), which can be used to calculate the Wiener filter tap values as follows:

$${h}_{T x} ( t ) := {( Toeplitz ( {R}_{{ϕ}_{T}} ( t ) ) )}^{- 1} \cdot {R}_{{ϕ}_{T} , {v}_{T x}} ( t )$$

where Toeplitz(x̅) is a Toeplitz matrix whose first row and first column are equal to vector x̅. The Wiener filter solution h_{Rx}(t) for the Rx laser frequency estimation can be derived in a manner similar to that for the Tx laser frequency estimation.

Letting the Tx and Rx laser frequency noise estimates \hat{v}_{Tx}(t) and \hat{v}_{Rx}(t) be defined as:

$${\hat{v}}_{T x} ( t ) : = {h}_{T x} ( t ) * {ϕ}_{T} ( t )$$

$${\hat{v}}_{R x} ( t ) : = {h}_{R x} ( t ) * {ϕ}_{R} ( t ) ,$$

the Tx and Rx differential laser corrections for frequency f may be calculated as follows:

$${ψ}_{Tx , b} ( f ) : = {\hat{v}}_{Tx} ( b + ⌊ {o}_{T} ( f ) ⌋ ) \cdot ( {o}_{T} ( f ) - ⌊ {o}_{T} ( f ) ⌋ ) + {\sum }_{c = 0}^{⌊ {o}_{T} ( f ) ⌋ - 1} {\hat{v}}_{Tx} ( b + c )$$

$${ψ}_{Rx , b} ( f ) : = {\hat{v}}_{Rx} ( b + ⌊ {o}_{R} ( f ) ⌋ ) \cdot ( {o}_{R} ( f ) - ⌊ {o}_{R} ( f ) ⌋ ) + {\sum }_{c = 0}^{⌊ {o}_{R} ( f ) ⌋ - 1} {\hat{v}}_{Rx} ( b + c )$$

where o_{T}(f) and o_{R}(f) are the walk-off values associated with the Tx and Rx laser phase noises for frequency f against DC, and where ψ_{Tx,b}(f) and ψ_{Rx,b}(f) are the phase correction terms that can be applied to the content of frequency bin f of burst b such that the walk-off effects of the Tx and RX laser phase noises across the signal's spectrum are compensated for and thus the Tx and Rx laser phase noises are (e.g., completely) aligned across all frequency bins. The Tx and Rx laser phase noises across frequency can therefore be corrected or mitigated via rotation of content of the signal at the various frequencies in the two-dimensional (2D) complex plane by the walk-off correction amounts ψ_{Tx,b}(f) and ψ_{Rx,b}(f). Such rotation can involve multiplication by a complex value, the use of an algorithm such as a coordinate rotation digital computer (CORDIC), and/or other operations.

In a case where there are “K” FDM-subcarriers (K>2) in the received signal, where parallel signal streams at parallel frequencies all share the same optical carrier, the edgeless EEPN tracking algorithm can decouple the noise that is associated with the different subcarriers by using clock phase information relating to one or more (e.g., each) of the FDM subcarriers. This can result in better estimates of the Tx and Rx laser frequency noise values v_{Tx}(t) and v_{Rx}(t). Specifically, clock phase information corresponding to each of K FDM subcarriers can be obtained as follows:

$$∀ k \vert 0 \leq k \leq K - 1 \text{:} {ϕ}_{k} [ b ] : = Angle ( {\sum }_{f = - \frac{{F}_{s}}{2} + \frac{k \cdot {F}_{s}}{K}}^{- \frac{{F}_{s}}{2} + \frac{( k + 1 ) \cdot {F}_{s}}{K}} {s}^{H} [ f ] \cdot {r}_{b} [ f ] )$$

For instance, for K=4, the metric can be a vector of length four that includes the clock phase information corresponding to the 4 subcarriers:

$${ϕ}_{3} [ b ] := Angle ( {\sum }_{f = \frac{{F}_{s}}{4}}^{\frac{{F}_{s}}{2}} {s}^{H} [ f ] \cdot {r}_{b} [ f ] )$$

$${ϕ}_{2} [ b ] := Angle ( {\sum }_{f = 0}^{\frac{{F}_{s}}{4}} {s}^{H} [ f ] \cdot {r}_{b} [ f ] )$$

$${ϕ}_{1} [ b ] := Angle ( {\sum }_{f = - \frac{{F}_{s}}{4}}^{0} {s}^{H} [ f ] \cdot {r}_{b} [ f ] )$$

$${ϕ}_{0} [ b ] := Angle ( {\sum }_{f = - \frac{{F}_{s}}{2}}^{- \frac{{F}_{s}}{4}} {s}^{H} [ f ] \cdot {r}_{b} [ f ] )$$

In certain embodiments, multiple metrics may be obtained for each subcarrier, such as clock phase information for the positive and negative spectrum halves for each subcarrier, similar to that described above with respect to the equations φ₊[b]:=Angle(m₊[b]) and φ₋[b]:=Angle(m₋[b]). In these embodiments, the vector would have a longer length—e.g., eight in the case where two metrics per the 4 subcarriers are obtained and included in the vector.

The (e.g., optimum) multi-dimensional filters h_{Tx}(k, d), h_{Rx}(k, d) that provide the best estimates of the true Tx and Rx laser frequency noises can be learned. For example, tap values may be obtained based on an MMSE criterion that is determined by the Wiener filter solution:

$${\overline{h}}_{T x} := {argmin}_{\overline{h}} {\vert {v}_{T x} ( b ) - {\sum }_{k = 0}^{K - 1} {\sum }_{d = - D}^{D} h ( k , d ) \cdot {ϕ}_{k} [ b - d ] \vert}^{2}$$

$${\overline{h}}_{R x} := {argmin}_{\overline{h}} {\vert {v}_{R x} ( b ) - {\sum }_{k = 0}^{K - 1} {\sum }_{d = - D}^{D} h ( k , d ) \cdot {ϕ}_{k} [ b - d ] \vert}^{2}$$

The multi-dimensional Wiener filter can then be applied to estimate the Tx and Rx laser frequency noises as follows:

$${\hat{v}}_{T x} ( b ) = {\sum }_{k = 0}^{K - 1} {\sum }_{d = - D}^{D} {h}_{T x} ( k , d ) \cdot {ϕ}_{k} [ b - d ]$$

$${\hat{v}}_{R x} ( b ) = {\sum }_{k = 0}^{K - 1} {\sum }_{d = - D}^{D} {h}_{R x} ( k , d ) \cdot {ϕ}_{k} [ b - d ]$$

where the steps for calculating the Tx and Rx differential laser corrections for frequency f and applying the phase corrections, as described above, may be similarly performed for the K subcarriers.

FIG. 2A is a high-level block diagram 250 illustrating an example location of the EEPN tracker/compensator algorithm in the signal flow relative to other digital processing blocks in a receiver, in accordance with various aspects described herein. As shown, the EEPN tracker/compensator block 250e (which may implement the Rx EEPN tracker algorithm or the edgeless EEPN tracker algorithm described herein) may be located downstream of chromatic dispersion compensation and clock phase detection, but upstream of carrier phase recovery.

It is to be understood and appreciated that above-described derivations of the Rx EEPN tracking algorithm and the edgeless EEPN tracking algorithm rely on simplified assumptions for purposes of brevity and clarity. In practice, numerous variations are possible and thus aspects of one or more of these tracking algorithms may be adapted accordingly. For instance, AWGN, other noise, nonlinear degradations, clock jitter, and/or clock phase offset can be present. There might be multiple clock phase detectors rather than just one. At least some of the symbols in the received signal may be correlated. While the derivations generally focused on the X-pol, the received signal can be dual-polarization. The polarization(s) can also be subject to polarization rotation, polarization dependent loss, and/or polarization mode dispersion.

As some other examples, in addition to Rx digital compensation for chromatic dispersion, Tx digital compensation for chromatic dispersion can also be present. The Rx chromatic dispersion compensation might be distributed in multiple functional blocks, or might be combined with other functions such as in digital back propagation. The amount of Rx chromatic dispersion compensation might be low or minimal, with the (e.g., vast) majority of the chromatic dispersion compensation being in the Tx. Within any given FFT block, the Tx and/or Rx laser phase noise can, of course, vary. At least some FFT blocks can also overlap with one another. The overall communication system may or may not use FFTs—e.g., the system might use other chromatic dispersion compensation techniques, such as those involving time domain FIR or IIR or Fermat transforms. The spectral width of the received signal can be greater than the baud rate (e.g., it may have a Root Raised Cosine spectrum), can be Nyquist, or can be narrower than the baud rate. In a scenario where multiple FDM symbol streams are present in the received signal, the Rx EEPN tracking algorithm or the edgeless EEPN tracking algorithm can be applied to each such stream separately or, alternatively, to some or all of the streams jointly.

While the differential approach taken in the derivations of the exemplary tracking algorithms above is advantageous, absolute methods or other methods can alternatively be used. Also, while it is generally convenient to be differential relative to the phase at frequency f=0, other single or plural base frequencies can alternatively be used.

While it is advantageous to have carrier phase detection completely downstream of the EEPN compensation, carrier phase detection might be implemented in multiple blocks, in which case only some of these blocks, for instance, may be downstream of the EEPN compensation.

The Rx laser can have relative intensity noise (RIN), crosstalk, microphonics, power supply ripple, dithers, and/or other imperfections, which either tracking algorithm may be adapted to account for. Rather than using a laser as the Rx light source, an extracted optical tone, a comb, or other optical, analog, or digital methods of creating optical mixing products can alternatively be used in the Rx.

Different Tx and Rx lasers may be utilized, and thus these lasers can have different phase noise characteristics. The laser offset frequency (or intermediate frequency (IF)—i.e., f_{IF}) can be near zero or, alternatively, a larger, fixed or variable IF can be used in the system.

The overall hardware unit that encompasses the various processing blocks can be single-directional or bidirectional. Aspects of either tracking algorithm can be improved or optimized for heat, such as with a plug (i.e., pluggable optics), or can be improved or optimized for performance as desired.

It is generally advantageous to digitally compensate for chromatic dispersion in the received signal, and then estimate the clock phase from the resulting compensated signal. In some implementations, the received signal (or portion(s) thereof) can alternatively be duplicated, prior to the main chromatic dispersion compensation, for the purpose of clock phase detection, where certain required chromatic dispersion compensation is performed and incorporated into the beginning stages of the clock phase detection algorithm. In these implementations, the clock phase estimation may be downstream of this incorporated compensation, and the Rx EEPN tracking method may utilize information from such clock phase estimation.

In various embodiments, either of the Rx EEPN tracking algorithm or the edgeless EEPN tracking algorithm can be combined with other method(s) that are implemented at other locations in the signal flow. For example, either EEPN tracking algorithm can be combined with processing that is associated with the optical detection of the Rx laser phase.

While the advantageous EEPN tracking algorithms are described herein as involving the use of detected clock phase, other clock-phase related information—e.g., some precursor information that is obtained prior to determining the clock phase, some scaled value that is associated with the detected clock phase, etc.—can alternatively be used.

It is to be understood and appreciated that, although one or more of FIGS. 1A-1C and 2A might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various components, devices, systems, modules, circuits, etc. may have been illustrated in one or more of FIGS. 1A-1C and 2A as separate components, devices, systems, modules, circuits, etc., it will be appreciated that multiple components, devices, systems, modules, circuits, etc. can be implemented as a single component, device, system, module, circuit, etc., or a single component, device, system, module, circuit, etc. can be implemented as multiple components, devices, systems, modules, circuits, etc. Additionally, functions described as being performed by one component, device, system, module, circuit, etc. may be performed by multiple components, devices, systems, modules, circuits, etc., or functions described as being performed by multiple components, devices, systems, modules, circuits, etc. may be performed by a single component, device, system, module, circuit, etc.

FIG. 2B depicts an illustrative embodiment of a method 270 in accordance with various aspects described herein.

At 270a, the method can include calculating, by an EEPN compensation system of a coherent optical receiver, at least one metric, wherein the coherent optical receiver includes a chromatic dispersion compensation system configured to digitally compensate for chromatic dispersion relating to a signal, and a carrier phase recovery system configured to digitally recover a carrier phase associated with the signal, and wherein the calculating is based on information that is downstream of the chromatic dispersion compensation system. For example, the EEPN tracker/compensator 250e of a coherent optical receiver, such as the receiver 4′, may, similar to that described above with respect to FIG. 2A, perform one or more operations that include calculating at least one metric relating to clock phase, where the receiver 4′ includes a chromatic dispersion compensation system configured to digitally compensate for chromatic dispersion relating to a signal, and a carrier phase recovery system configured to digitally recover a carrier phase associated with the signal, and where the calculating is based on information that is downstream of the chromatic dispersion compensation system.

At 270b, the method can include utilizing, by the EEPN compensation system, the at least one metric to perform EEPN compensation relating to the signal upstream of the carrier phase recovery system. For example, the EEPN tracker/compensator 250e may, similar to that described above with respect to FIG. 2A, perform one or more operations that include utilizing the at least one metric to perform EEPN compensation relating to the signal upstream of the carrier phase recovery system.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc. Furthermore, the use of the term approximating or approximation herein can include or involve satisfying particular thresholds in whole or in part.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments. Additionally, functions described as being performed by one component or system may be performed by multiple components or systems, or functions described as being performed by multiple components or systems may be performed by a single component or system, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A coherent optical receiver, comprising:
an equalization enhanced phase noise (EEPN) compensation system that is configured to perform operations, including
calculating at least one metric based on information that is downstream of a chromatic dispersion compensation system that digitally compensates for chromatic dispersion relating to a signal, and
utilizing the at least one metric to perform EEPN compensation relating to the signal upstream of a carrier phase recovery system that digitally recovers a carrier phase associated with the signal.

2. The coherent optical receiver of claim 1, wherein the at least one metric is a scalar.

3. The coherent optical receiver of claim 1, wherein the at least one metric is related to clock phase.

4. The coherent optical receiver of claim 1, wherein the calculating involves one or more clock phase detection operations.

5. The coherent optical receiver of claim 1, wherein the calculating involves frequency domain operations.

6. The coherent optical receiver of claim 1, wherein the calculating involves time domain operations.

7. The coherent optical receiver of claim 1, wherein the calculating involves use of known received symbols.

8. The coherent optical receiver of claim 1, wherein the EEPN compensation comprises an estimation of a receiver (Rx) or transmitter (Tx) laser phase noise at a first frequency relative to a second frequency.

9. The coherent optical receiver of claim 1, wherein the EEPN compensation comprises a compensation operation for a receiver (Rx) or transmitter (Rx) laser phase noise at a first frequency relative to a second frequency.

10. The coherent optical receiver of claim 1, wherein the at least one metric is a vector.

11. The coherent optical receiver of claim 1, wherein the signal comprises N frequency division multiplexing (FDM) streams.

12. The coherent optical receiver of claim 11, wherein the at least one metric has a length equal to N or 2N.

13. The coherent optical receiver of claim 1, wherein the at least one metric comprises distinct elements that correspond to frequency division multiplexing (FDM) streams that are arranged across a plurality of positive frequencies or a plurality of negative frequencies.

14. A method, comprising:
calculating, by an equalization enhanced phase noise (EEPN) compensation system of a coherent optical receiver, at least one metric,
wherein the coherent optical receiver includes a chromatic dispersion compensation system configured to digitally compensate for chromatic dispersion relating to a signal, and a carrier phase recovery system configured to digitally recover a carrier phase associated with the signal, and
wherein the calculating is based on information that is downstream of the chromatic dispersion compensation system; and
utilizing, by the EEPN compensation system, the at least one metric to perform EEPN compensation relating to the signal upstream of the carrier phase recovery system.

15. The method of claim 14, wherein the at least one metric is a scalar.

16. The method of claim 14, wherein the at least one metric is related to clock phase.

17. The method of claim 14, wherein the at least one metric comprises a vector.

18. The method of claim 14, wherein the calculating involves one or more clock phase detection operations.

19. The method of claim 14, wherein the calculating involves frequency domain operations.

20. A non-transitory machine-readable medium, comprising executable instructions that, when executed by a processing system of a coherent optical receiver including a processor, facilitate performance of operations, the operations comprising:
calculating at least one metric,
wherein the coherent optical receiver includes a chromatic dispersion compensation system configured to digitally compensate for chromatic dispersion relating to a signal, and a carrier phase recovery system configured to digitally recover a carrier phase associated with the signal, and
wherein the calculating is based on information that is downstream of the chromatic dispersion compensation system; and
utilizing the at least one metric to perform edgeless EEPN compensation relating to the signal upstream of the carrier phase recovery system.
